(19) United States
(12) Patent Application Publication
(10) Pub. No.: US 2012/0137345 A1
(43) Pub. Date: May 31, 2012

(54) SYSTEM AND METHOD FOR CYBER OBJECT PROTECTION USING VARIABLE CYBER COORDINATES (VCC)

(75) Inventor: Victor I. Sheymov, Vienna, VA (US)

(73) Assignee: INVICTA NETWORKS, INC., Reston, VA (US)

(21) Appl. No.: 13/389,272

(22) PCT Filed: Aug. 9, 2010
(86) PCT No.: PCT/US2010/044904

§ 371 Date: Feb. 7, 2012

Related U.S. Application Data
(60) Provisional application No. 61/272,026, filed on Aug. 10, 2009.

(51) Int. Cl. G06F 21/00

(52) U.S. Cl. 726/3

(57) ABSTRACT

A method, system, and computer program product for cyber protection using variable cyber coordinates (VCC), including a variable cyber coordinates (VCC) controller unit configured to generate cyber coordinates based on a VCC protocol for respective control circuits (CC) of one or more protected routers; and the VCC controller unit configured to communicate the generated cyber coordinates to the protected routers with or without encryption and/or authentication. At a predetermined time interval or based on a command from the VCC controller unit, the routers and their respective control units (CU) are configured to change their cyber coordinates together or separately, to cyber coordinates newly generated by the VCC controller unit according to the VCC protocol.

### CROSS REFERENCE TO RELATED APPLICATIONS

The present invention claims benefit of priority to U.S. Provisional patent application Ser. No. 61/272,026 of SHEYMOV, entitled “SYSTEM AND METHOD FOR CYBER OBJECT PROTECTION USING VARIABLE CYBER COORDINATES (VCC),” filed on Aug. 10, 2009, the entire disclosure of which is hereby incorporated by reference herein.

### BACKGROUND OF THE INVENTION

1. Field of the Invention

This invention relates to systems and methods for providing network security against cyber attacks over communications networks. In particular, this invention relates to systems and methods for cyber protection using variable cyber coordinates (VCC).

2. Discussion of the Background

Recent increase in cyber attacks, such as hacker attacks, and the like, and the corresponding activity in cyber defense, including cyber attack detection, and especially protection against cyber attacks remain at a minimal level of sophistication.

### SUMMARY OF THE INVENTION

The above and other problems are addressed by exemplary embodiments of the present invention, which advantageously provide a novel system and method for cyber protection using variable cyber coordinates (VCC).

Accordingly, aspects of the present invention relate to a method, system, and computer program product for cyber protection using variable cyber coordinates (VCC), including a variable cyber coordinates (VCC) controller unit configured to generate cyber coordinates based on a VCC protocol for respective control circuits (CC) of one or more protected routers; and the VCC controller unit configured to communicate the generated cyber coordinates to the protected routers with or without encryption and/or authentication. At a predetermined time interval or based on a command from the VCC controller unit, the routers and their respective control units (CU) are configured to change their cyber coordinates together or separately, to cyber coordinates newly generated by the VCC controller unit according to the VCC protocol.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIGS. 1-2 are functional block diagrams for illustrating an exemplary router system; and

FIG. 3 is a functional block diagram illustrating an exemplary system and method for cyber protection using variable cyber coordinates (VCC).

### DETAILED DESCRIPTION OF THE INVENTION

This invention generally relates to systems and methods for protection of communications between cyber objects, and more particularly to systems and methods for protection of communications between cyber objects using Variable Cyber Coordinates (VCCs).

Generally, the exemplary systems and methods can be used to protect communications between cyber objects, such as routers, voice and telephony switches, base stations, Supervisory Control and Data Acquisition (SCADA) devices, computers, databases, or portions or components or circuitry or devices thereof, and the like, which can be indentified by one or more cyber coordinates, such as addresses, IP addresses, port addresses, MAC addresses, phone numbers, file names, and the like.

The present invention includes recognition that among all the types of cyber attacks present today, attacks on a network infrastructure itself are gaining increasing popularity. Such attacks are difficult to defend against, and are the most dangerous types of cyber attacks by their nature, since they can cripple an entire network, the Internet, and the like, with devastating consequences.

For example, attacking a cyber object can be beneficial to a perpetrator in several different ways. In the case of a cyber object, such as a router control circuit, and the like, the attack can give the perpetrator the ability manipulate policies and performance of the router, impact performance of other surrounding routers, as well as to enable the perpetrator to watch the through traffic and use the compromised router as a launching pad for various attacks, such as the “man-in-the-middle” attacks, and the like. Accordingly, such weakness has made routers an increasingly popular target of cyber attacks in recent years. Such potential dangers make protection of, for example, the control circuits, and the like, of a router a paramount security concern.

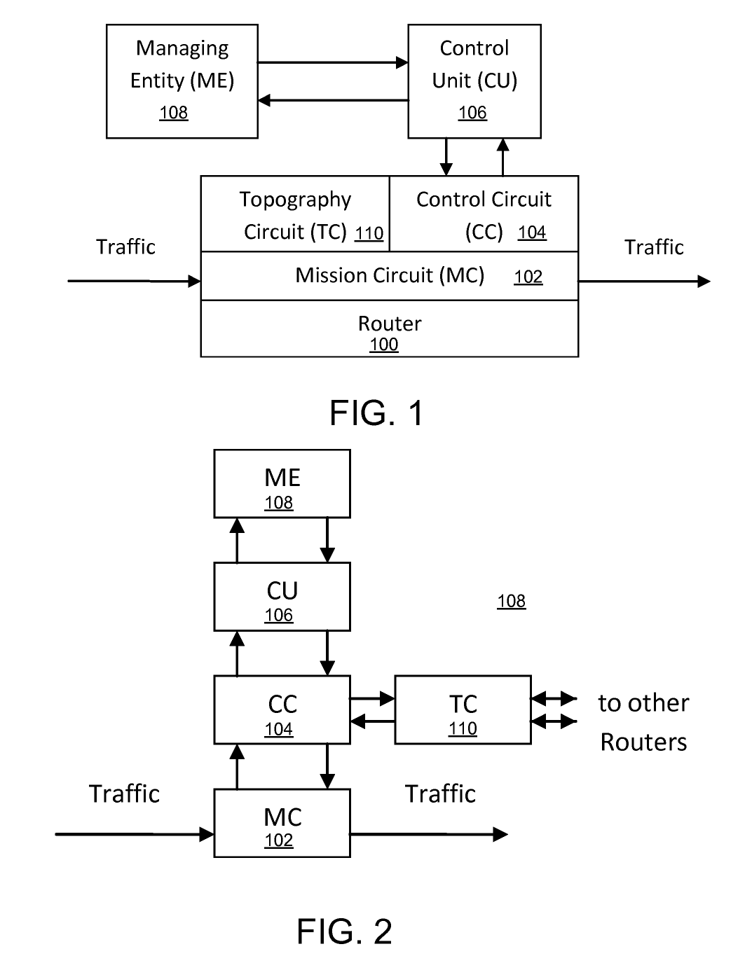

In a simplified way, as shown in the FIGS. 1-2, a router 100 can be viewed as including the following functional components or circuits:

a mission circuit (MC) 102, such as the parts or components of the router that route passing traffic by executing a routing policy of the router;

a control circuit (CC) 104, such as the parts or components of the router that accept the routing policy from a router control unit (CU) 106 of the managing entity 108 (MW, e.g., an ISP, a TelCo, etc.) of the router, that store the policy, and that pass the policy on to the mission circuit for execution; and

a topography circuit (TC) 110, such as the parts or components of the router that exchange the surrounding network topography information with other routers in the cyber vicinity of the router in order to enhance network performance.

The present invention includes recognition that an attack on a cyber object, such as a router, and the like, can be performed, for example:

directly, by penetrating the control circuit of the router and either modifying the existing routing policy or taking over the control of the router and maintaining full control over its functions; and

indirectly, by broadcasting false topography information either from another router or by mimicking another router and thus manipulating the behavior of the target router.

With this in mind, it becomes advantageous to provide reliable protection of cyber objects, such as the control circuits or parts or components thereof of routers, and the like. In an exemplary embodiment, this is accomplished by utilizing the Variable Cyber Coordinates (VCC) protocol for communications protection, for example, as further described in commonly assigned, U.S. patent application Ser. No. 11/712,458 (Publication No. US 2007/0162754 A1) of Victor I. Sheymov, entitled “METHOD OF COMMUNICATIONS AND COMMUNICATION NETWORK INTRUSION PROTECTION METHODS AND INTRUSION ATTEMPT DETECTION SYSTEM,” filed on Mar. 1, 2007, now U.S. Pat. No. 7,650,502, incorporated by reference herein in its entirety.

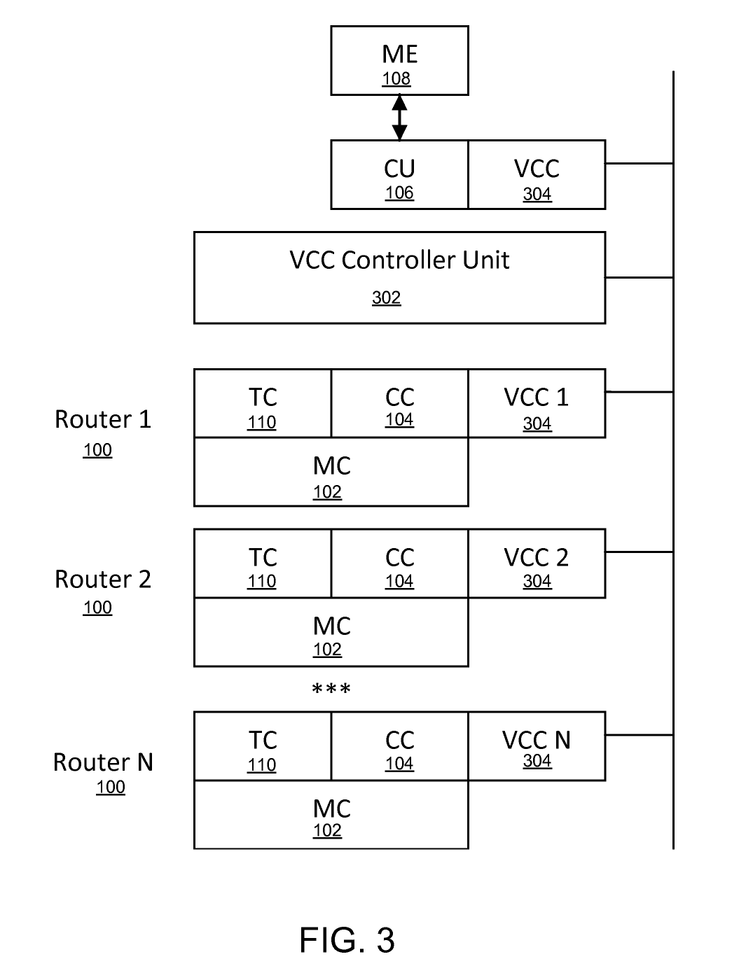

Accordingly, in an exemplary embodiment, as shown in FIG. 3, the managing entity (ME) of one or more routers (R1, R2 . . . RN), through the control unit (CU) of the managing entity, employs a VCC controller unit (VCU) for establishing VCC enabled communications with the one or more routers under its control.

In accordance with the VCC protocol, the VCC controller unit 302 generates random numbers, and the like, and assigns them as cyber coordinates to the respective control circuits (CC) 104 of the one or more routers 100, and communicates the generated cyber coordinates to the protected routers, for example, with or without encryption, authentication, and the like. At a predetermined time interval (e.g., seconds, minutes, hours, at a random interval, etc.) or on a command from the VCC controller unit 102, and the like, the routers 100 and their control units (CU) 104 change their cyber coordinates together or separately, to newly generated ones according to the VCC protocol 304. The process is repeated for the new “jump” cycle. Advantageously, the exemplary system and method allows a control circuit of a router, and the like, to be protected using the principals of the VCC protocol.

The exemplary system and method further enables the managing entity to establish a strongly protected enclave of routers. This, in turn, enables the protected routers to reliably differentiate topography information coming from other routers, for example, based on whether or not such routers are ‘trusted,” i.e., belong to the protected enclave or other affiliated trusted or relatively trusted enclaves, or other routers that are considered “unknown” and thus whose information should be viewed with a certain degree of caution. For example, if unusual topography information is received from an “unknown” router, such router can be placed under “quarantine,” verified, and the like, and an appropriate alarm, notification, and the like, can be issued.

Although the exemplary systems and methods have been described with respect to protect communications between routers, the exemplary systems and methods are applicable to any suitable cyber objects, such as voice and telephony switches, base stations, Supervisory Control and Data Acquisition (SCADA) devices, computers, databases, or portions or components or circuitry or devices thereof, and the like, which can be indentified by one or more cyber coordinates, such as addresses, IP addresses, MAC addresses, port addresses, phone numbers, file names, and the like, as will be appreciated by those of ordinary skill in the revenant art(s).

The devices and subsystems of the exemplary embodiments can be implemented either on a single programmed general purpose computer or a separate programmed general purpose computer. However, the exemplary system can also be implemented on a special purpose computer, a programmed microprocessor or microcontroller and peripheral integrated circuit element, an ASIC or other integrated circuit, a digital signal processor, a hardwired electronic or logic circuit such as a discrete element circuit, a programmable logic device such as PLD, PLA, FPGA, PAL, or the like. In general, any device capable of implementing a finite state machine that is in turn capable of implementing the methods of the exemplary embodiments can be used to implement the exemplary system according to this invention.

Furthermore, the disclosed methods may be readily implemented in software using object or object-oriented software development environments that provide portable source code that can be used on a variety of computer or workstation hardware platforms. Alternatively, the exemplary system can be implemented partially or fully in hardware using standard logic circuits or VLSI design. Whether software or hardware is used to implement the systems in accordance with this invention is dependent on the speed and/or efficiency requirements of the system, the particular function, and the particular software and/or hardware systems or microprocessor or microcomputer systems being utilized. However, the exemplary system and method illustrated herein can be readily implemented in hardware and/or software using any known or later-developed systems or structures, devices and/or software by those of ordinary skill in the applicable art from the functional description provided herein and with a general basic knowledge of the computer arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer, such as a JAVA.RTM. or CGI script, as a resource residing on a server or workstation, a routine embedded on a dedicated system, a web browser, a PDA, a dedicated system, or the like. The exemplary system can also be implemented by physically incorporating the system into a software and/or hardware system, such as the hardware and software systems of a computer workstation or a dedicated system.

Thus, the devices and subsystems of the exemplary embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, etc. Non-volatile media can include, for example, optical or magnetic disks, magneto-optical disks, and the like. Volatile media can include dynamic memories, and the like. Transmission media can include coaxial cables, copper wire, fiber optics, and the like. Common forms of computer-readable media can include, for example, a floppy disk, a flexible disk, hard disk, magnetic tape, any other suitable magnetic medium, a CD-ROM, CDRW, DVD, any other suitable optical medium, a RAM, a PROM, an EPROM, a FLASH-EPROM, any other suitable memory chip or cartridge, or any other suitable medium from which a computer can read.

It is, therefore, apparent there has been provided in accordance with the present invention, systems and methods for protection of communications between cyber objects using Variable Cyber Coordinates (VCCs). While this invention has been described in conjunction with a number of embodiments, it is evident that many alternatives, modifications, and variations would be or are apparent those of ordinary skill in the applicable art. Accordingly, the invention is intended to embrace all such alternatives, modifications, equivalents and variations that are within the spirit and scope of this invention.

What is claimed is:

1. A system for cyber protection using variable cyber coordinates (VCCs), the system comprising:
a variable cyber coordinates (VCC) controller unit configured to generate cyber coordinates based on a VCC protocol for respective control circuits (CC) of one or more protected routers; and
the VCC controller unit configured to communicate the generated cyber coordinates to the protected routers with or without encryption and/or authentication,
wherein at a predetermined time interval or based on a command from the VCC controller unit, the routers and their respective control units (CU) are configured to change their cyber coordinates together or separately, to cyber coordinates newly generated by the VCC controller unit according to the VCC protocol.

2. A method for cyber protection using variable cyber coordinates (VCCs), the method comprising:
generating by a variable cyber coordinates (VCC) controller unit cyber coordinates based on a VCC protocol for respective control circuits (CC) of one or more protected routers;
communicating by the VCC controller unit the generated cyber coordinates to the protected routers with or without encryption and/or authentication; and
at a predetermined time interval or based on a command from the VCC controller unit, changing by the routers and their respective control units (CU) their cyber coordinates together or separately, to cyber coordinates newly generated by the VCC controller unit according to the VCC protocol.

3. A computer program for cyber protection using variable cyber coordinates (VCCs), and including one or more computer readable instructions embedded on a computer readable medium and configured to cause one or more computer processors to perform the steps of:
generating by a variable cyber coordinates (VCC) controller unit cyber coordinates based on a VCC protocol for respective control circuits (CC) of one or more protected routers;
communicating by the VCC controller unit the generated cyber coordinates to the protected routers with or without encryption and/or authentication; and
at a predetermined time interval or based on a command from the VCC controller unit, changing by the routers and their respective control units (CU) their cyber coordinates together or separately, to cyber coordinates newly generated by the VCC controller unit according to the VCC protocol.
